(19) United States
(12) Patent Application Publication
(10) Pub. No.: US 2026/0114668 A1
(43) Pub. Date: Apr. 30, 2026

(54) Electric Grill with Enhanced Conductive Heating

(71) Applicant: W.C. Bradley Co., Columbus, GA (US)

(72) Inventors: Ramin Khosravi RAHMANI, Columbus, GA (US); James D. KRING, Opelika, AL (US); Sleiman ABDALLAH, Columbus, GA (US); Thomas Kessler, Columbus, GA (US)

(21) Appl. No.: 19/170,896

(22) Filed: Apr. 4, 2025

Related U.S. Application Data
(60) Provisional application No. 63/574,705, filed on Apr. 4, 2024.

(51) Int. Cl. A47J 37/07; A47J 36/32; A47J 37/06; F24C 7/06; H05B 1/02; H05B 3/06; H05B 3/14

(52) U.S. Cl. CPC A47J 37/0709; A47J 36/32; A47J 37/0676; F24C 7/06; H05B 1/0261; H05B 3/06; H05B 3/145; H05B 2203/005; H05B 2203/013; H05B 2214/04

(57) ABSTRACT

An electric cooking device having an electrically powered heat source that provides thermal energy to a cooking surface, and a lid that closes to cover the cooking surface, the lid having a searing tube that provides radiative heat toward the cooking surface.

### CROSS-REFERENCE TO RELATED CASES

This application claims the benefit of U.S. provisional patent application Ser. No. 63/574,705, filed on Apr. 4, 2024, and incorporates such provisional application by reference into this disclosure as if fully set out at this point.

### FIELD OF THE INVENTION

This disclosure relates to cooking appliances in general and, more specifically, to an electric cooking grill with directly heated cooking surfaces and/or overhead searing elements.

### BACKGROUND OF THE INVENTION

Existing electrical grills utilize a resistive heating element below a grate or other cooking surface. Electrical power energizes the heating element which radiates heat in all directions. Some of the energy is transferred to the cooking surface to heat or cook food but much of it is lost.

Grills that generate heat from a hydrocarbon fuel (such as gas or charcoal grills) benefit from multiple heat transfer mechanisms, including both radiative and convective transfers. Electric grills lack energy transfer into the cooking chamber via convective mass transfer (e.g., combustion products generated in a gas or charcoal grill). Additionally, the radiative nature of electric heating element designs lead to a large portion of the generated heat to be emitted away from the cooking surface producing an inefficient heat transfer mechanism. This results in a longer initial warmup time for the grill, a longer recovery time, and lower temperature and heat available for cooking inside the cooking chamber. It also significantly limits the size of the cooking surface available in an electric grill/griddle.

As combustion products travel through a cooking chamber, they provide radiative heat to the food from the above, allowing for browning the food surface. Current electric grills or griddles provide one-sided heat. Also, since the heat is generated across the axis of the electric heating element, the heat intensity is significantly higher along the line of the heating element. Heat intensity drops significantly as the distance increases from the axial line of the heating element (with a second order reverse correlation). Therefore the heat distribution across the cooking surface is very uneven.

Another limitation of the current electric grills/griddles is the lack of intelligent power distribution. Most systems have only one heat source, such as one large electric heating element, for the entire cooking chamber. Even having two heating elements, prior products are limited in how they manage the power supply. They may only utilize a manual-set control knob (similar to traditional convective gas grills).

What is needed is a system and method for addressing the above and related problems.

### SUMMARY OF THE INVENTION

The invention of the present disclosure, in one aspect thereof, comprises an electric cooking device having an electrically powered heat source that provides thermal energy to a cooking surface, and a lid that closes to cover the cooking surface, the lid having a searing tube that provides radiative heat toward the cooking surface.

The lid may have at least one other searing tube that provides radiative heat toward the cooking surface. The searing tube and the at least one other searing tube may be separately activated by a controller. The electrically powered heat source may comprise a resistive heating element. The cooking surface may be provided by a cooking grate in contact with the resistive heating element. The resistive heating element may be at least partially embedded into the cooking grate.

The electric cooking device may further comprising a temperature probe in contact with a bottom side of the cooking grate on an opposite side from the cooking surface. In some embodiments a plurality of temperature sensors in contact with a bottom side of the cooking grate on an opposite side from the cooking surface. A temperature probe may be embedded in the cooking grate. A plurality of temperature sensors may be embedded in the cooking grate.

In some embodiments, the cooking surface comprises a griddle and the electrically powered heat source comprises a graphene heating element applied to the griddle on a back side opposite from the cooking surface. In some embodiments the cooking surface comprises a cooking grate and the electrically powered heat source comprises a graphene heating element applied to the cooking grate on a back side opposite from the cooking surface. The cooking grate comprises an infrared cooking grate with a plurality of spaced apart ribs on the cooking surface and a plurality of valleys between adjacent ones of the ribs, the plurality of valleys each defining a plurality of openings from the cooking surface through the cooking grate.

The invention of the present disclosure, in another aspect thereof, comprises an electric cooking device having a plurality of cooking grates forming a cooking surface, each of the plurality of cooking grates having a separate electrically powered heat source, and a lid that closes to cover the cooking surface, the lid having a plurality of separately activated searing tube that provide radiative heat toward the cooking surface.

The the separate electrically powered heat source of each of the plurality of cooking grates may heat the respective cooking grate through contact with the respective cooking grate. The separate electrically powered heat source of each of the plurality of cooking grates may comprises a resistive heating element. The separate electrically powered heat source of each of the plurality of cooking grates may be at least partially embedded into the respective cooking grate.

In some embodiments, each of the plurality of cooking grates is in contacted by a temperature probe.

In some embodiments, each of the plurality of cooking grates is heated by a graphite heating element applied to the cooking grate on an opposite side from the cooking surface.

The invention of the present disclosure, in another aspect thereof, comprises an electric cooking device having a griddle forming at least part of a cooking surface, the griddle being heated by a graphene heating element applied to a side of the griddle opposite the cooking surface, and a lid that closes to cover the cooking surface, the lid having a plurality of separately activated searing tube that provide radiative heat toward the cooking surface.

### BRIEF DESCRIPTION OF THE DRAWINGS

FIG. 1 is a graphic illustration of an electric grill with symmetric radiation from a heating element leading to energy loss.

FIG. 2A is an exploded perspective view of one embodiment of an electric grill with lid-mounted searing tubes according to aspects of the present disclosure.

FIG. 2A is another exploded perspective view of the electric grill of FIG. 2A.

FIG. 3A is an inferior perspective view of one embodiment a lid with searing tubes according to aspects of the present disclosure.

FIG. 3B is a side cutaway view of the lid of FIG. 3A.

FIG. 4A provides an inferior perspective view of another embodiment of a lid with searing tubes according to aspects of the present disclosure.

FIG. 4B is a bottom view of the lid of FIG. 4A.

FIG. 5 is an illustration of the underside of the lid of FIG. 3A showing independent operation of searing tubes.

FIG. 6A is a plan view of one embodiment of a cooking grate according to aspects of the present disclosure.

FIG. 6B is an end view of the cooking grate of FIG. 6A

FIG. 7A is a plan view of another embodiment of a cooking grate according to aspects of the present disclosure.

FIG. 7B is an end view of the cooking grate of FIG. 7A.

FIG. 8A is a plan view of another embodiment of a cooking grate according to aspects of the present disclosure.

FIG. 8B is an end view of the cooking grate of FIG. 8A.

FIG. 9 is a perspective view of a griddle according to aspects of the present disclosure.

FIG. 10 is an inferior perspective view of the griddle of FIG. 9.

FIG. 11 is a bottom view of the griddle of FIG. 9.

FIG. 12 is a bottom perspective view of another embodiment of a griddle according to aspects of the present disclosure.

FIG. 13 is a bottom view of the griddle of FIG. 12.

FIG. 14 is a bottom perspective view of another embodiment of a griddle according to aspects of the present disclosure.

FIG. 15 is a bottom view of the griddle of FIG. 14.

FIG. 16 is another bottom view of the griddle of FIG. 14 with labelled electrodes.

FIG. 17 is a perspective view of one embodiment of a cooking grate according to aspects of the present disclosure.

FIG. 18 is a bottom perspective view of the cooking grate of FIG. 17.

FIG. 19 is a bottom view of the cooking grate of FIG. 17.

FIG. 20 is a side cutaway view of a portion of a graphene heating element formed into an emitter plate.

FIG. 21 a side cutaway view of the application of a graphene heating element to a bottom surface a cooking grate 600.

FIG. 22 is a simplified schematic diagram of a control system for a grill according to aspects of the present disclosure.

### DETAILED DESCRIPTION OF THE PREFERRED EMBODIMENTS

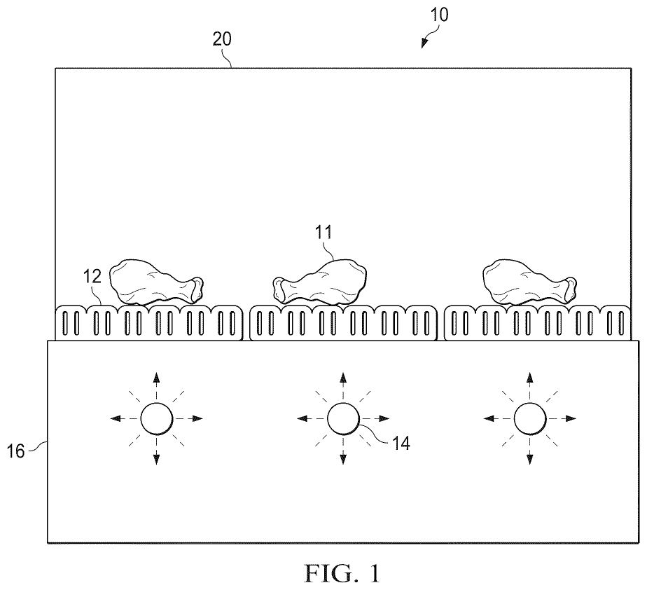

Referring now to FIG. 1, a graphic illustration of an electric grill 10 is shown. A simple electric grill 10 may be based on the principle of using one or a plurality of resistive heating elements 14 as a heat source. The heating elements 14 may be placed in a fire box 16 supporting a cooking grate 12 supporting food items 11 for cooking. A closable lid 20 may cover the food during cooking. The resistive heating elements 14 radiate heat in all directions into the firebox 16. This design lacks efficiency and control relative to designs described further hereinbelow.

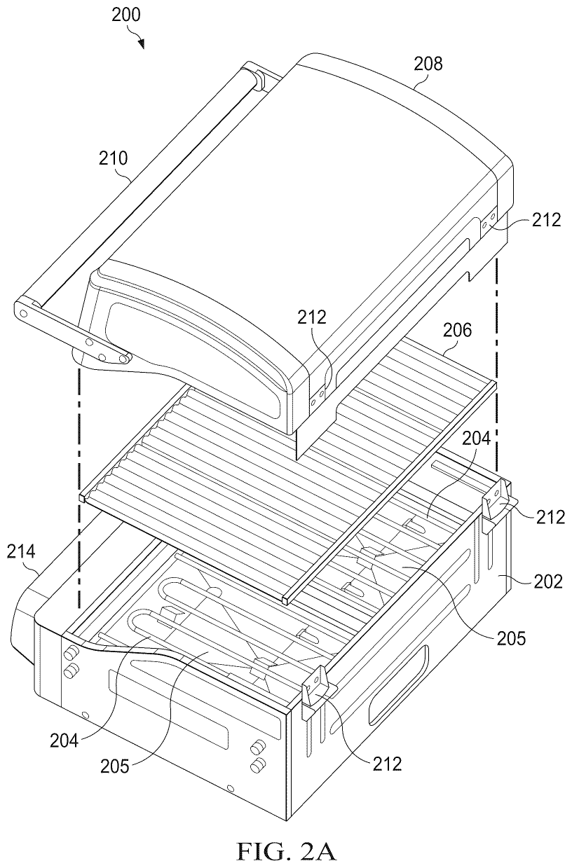

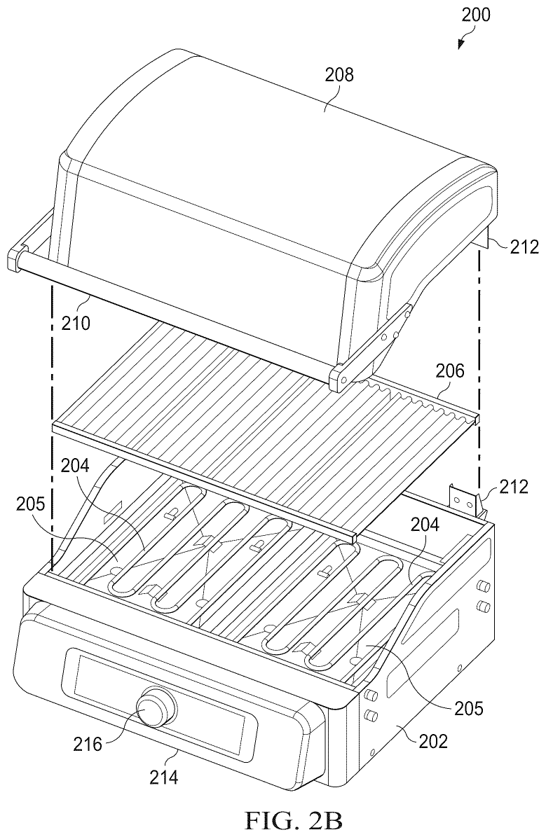

Referring now to FIG. 2A, a rear exploded perspective view of one embodiment of an electric grill 200 with lid-mounted searing tubes according to aspects of the present disclosure is shown. Referring also to FIG. 2B, a front exploded perspective view of the electric grill 200 is shown. A firebox 202 provides one or more electric heating elements 204. Where multiple heating elements are provided, these may be separately controlled to allow for zonal heating operations. The heating elements 204 may comprise resistive heating elements such as Calrod® devices. In some embodiments the heating elements 204 may comprise inductive heating devices.

Reflectors 205 may be placed below the heating elements 204 within the firebox 202 to reflect downwardly radiated heat back toward a cooking grate 206. The cooking grate 206 may be supported above the heating elements 204 by the firebox 202. The cooking grate 206 may be single unitary component, or may comprise separately removable sub grates.

A lid 208 may be provided to cover the cooking grate 206. A handle 210 may be provided on a front of the lid for raising and lowering the lid. The lid 208 may connect to the firebox 202 via hinges 212 at the rear.

The firebox 202 may provide a control panel 214 on a front portion thereof. A control knob 216 and other controls or switchgear as known to the art may be used to power the grill 200 on or off or to activate separate heating or cooking zones.

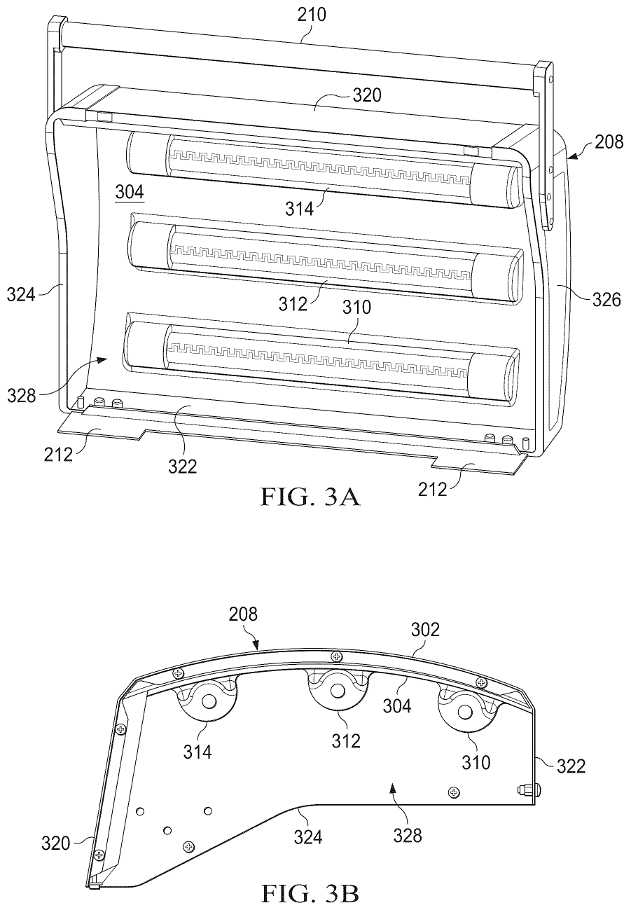

Referring now to FIG. 3A, an inferior perspective view of one embodiment a lid 208 with the searing tubes 310, 312, 314 according to aspects of the present disclosure is shown. FIG. 3B is a side cutaway view of the lid of FIG. 3A. The lid 208 may comprise a top 302 with an interior wall 304 or lid liner, to which the searing tubes 310, 312, 314 are attached. The interior wall may comprise a reflector or a reflective surface to direct radiative heat down toward the cooking grate 206. A protective mesh (not shown) may be placed below the searing tubes 310, 312, 314 to protect against grease splatter and direct contact with large food items.

Spaced apart to left and right sides of the searing tubes 310, 312, 314 are a left wall 324 and a right wall 326, respectively. These may join to the top 302 and/or interior wall 304. A front wall 320 may descend from the top 302 and/or interior wall 304. A rear wall 322 may descend from the top 302 and/or interior wall 304 and provide a location for joining the lid 208 to the firebox 202 with hinges 212. The interior wall 304, the sidewalls 324, 326, the front wall 320 and the rear wall 322 may be said to define an interior space 328. Such space is bound from below by the cooking grate 206 and/or firebox 202 when the lid 208 is closed.

One or a plurality of searing tubes 310, 312, 314 may be placed in the interior space 328 on the inside wall 304, and may run left to right in parallel. The searing tubes 310, 312, 314 are electrically powered and may be separately switched on or off manually (e.g., via control panel 214) or according to programming. The searing tubes 310, 312, 314 provide additional heat to the cooking grate 206 from above and can be used for browning, searing, or other heating operations. As known to the art, the heating element 204 and/or the searing tubes 310, 312, 314 may be operated based on a setpoint provided by the user and temperature(s) measurements as feedback input(s).

The searing tubes 310, 312, 314 heat up fast enough for the thermal inertia of the primary cooking surface (e.g., grate 206) to maintain most of its heat during a short interruption to power the searing tubes 310, 312, 314. Therefore near parallel top and bottom heat transfer is achieved. Such design allows for multi-directional heating to achieve browning effects as currently delivered by gas and charcoal grills. A user may sear one side of the meat or other food product as the opposite side is browned. The searing tubes 310, 312, 314 can provide faster warmup time, more uniform heat distribution, and multi-sided heat transfer within a larger cooking surface 206.

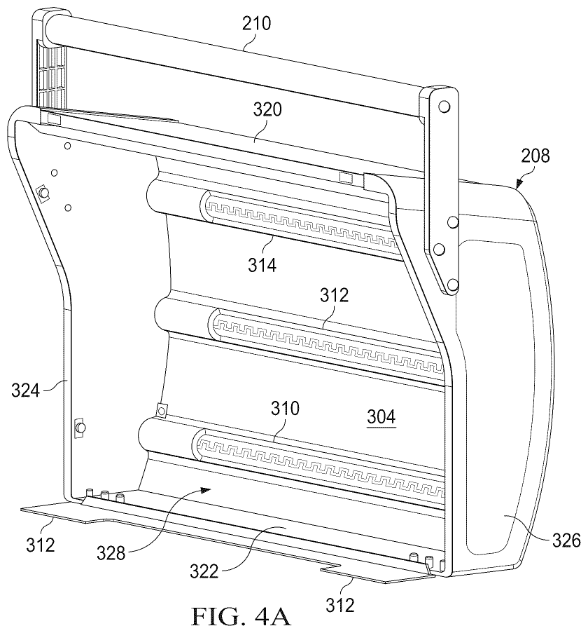

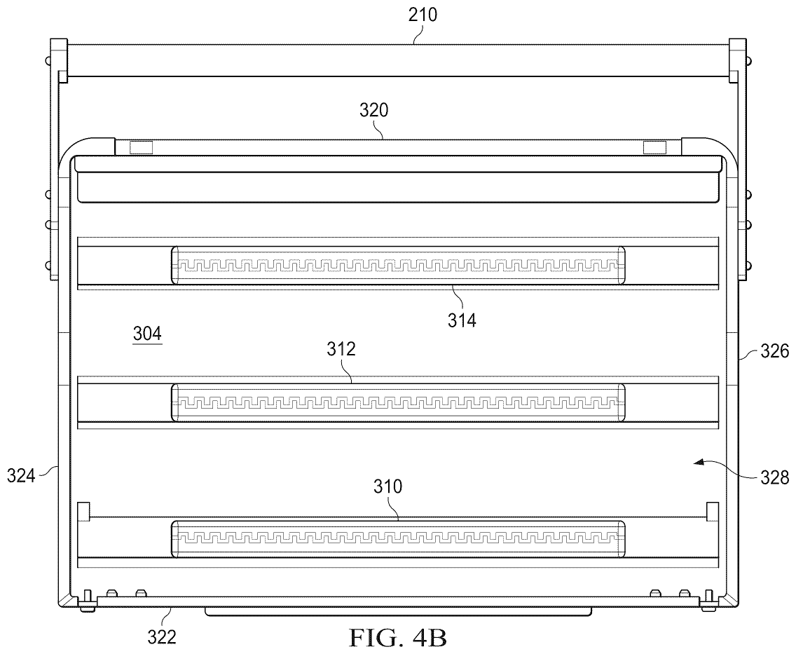

Referring now to FIG. 4A an inferior perspective view of another embodiment of a lid 208 with searing tubes according to aspects of the present disclosure is shown. FIG. 4B is a bottom view of the lid of FIG. 4A. Here the searing tubes 310, 312, 314 extend between the left wall 324 and the right wall 326, and may be connected to the walls 324, 326 as well. Such design allows for wiring for the searing tubes 310, 312, 314 to be placed in the walls 324, 326 (as opposed to interposing the top 302 and inner wall 304 as shown in FIGS. 3A-3B).

In other embodiments, the searing tubes 310, 312, 314 have a U-shaped geometry having both power connections at the same side. The searing tubes 310, 312, 314 may be mounted front to rear, rather than side to side. The searing tubes 310, 312, 314 may also follow the curvature of the lid 208 (e.g., specifically the top 302 and/or interior wall 304).

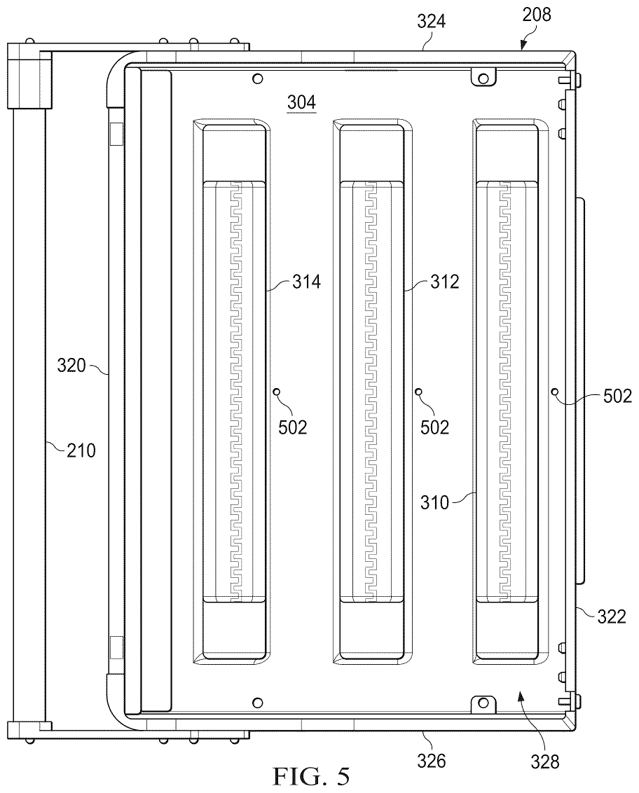

Referring now to FIG. 5, the bottom of lid 208 is shown. Here independent operation of the searing tubes 310, 312, 314 can be observed. The forward-most tube 314 and the central tube 312 are active, while rear-most tube 310 is switched off. In some embodiments, when the presence of a warming rack or other item is detected in the vicinity of tube, the power supply to that specific tube may be disconnected. In some cases, proximity detectors 502 may be utilized to this end. Power supplied to each searing tube 310, 312, 314 can also be at a different rate from the others.

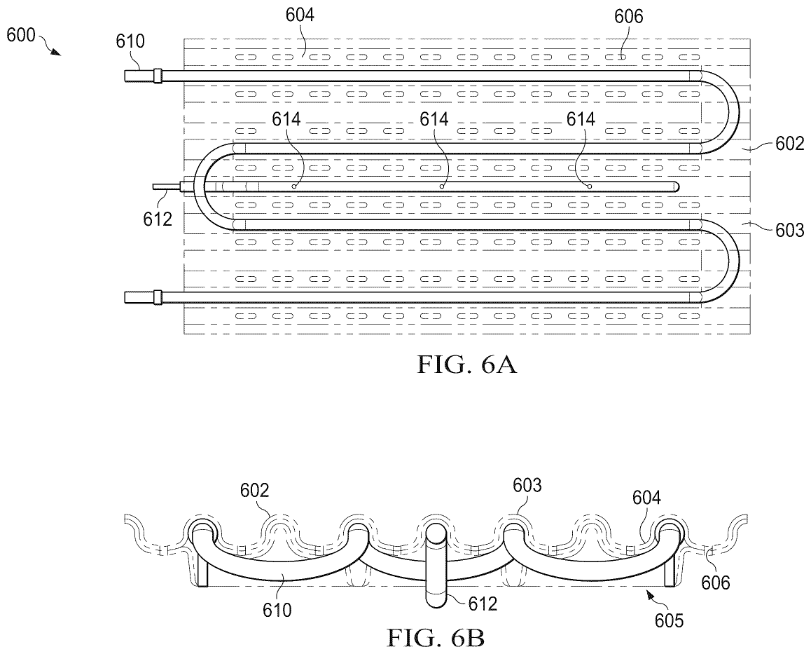

Referring now to FIG. 6A, a plan view of one embodiment of a cooking grate 600 according to aspects of the present disclosure is shown. FIG. 6B is an end view of the cooking grate 600. The cooking grate 600 may represent an entire cooking surface (e.g., cooking grate 206) or only a portion thereof. The cooking grate 600 may have a food contact side or surface 602 and an opposite bottom side 605. The cooking grate 600 may contain an embedded heating element 610. The cooking grate 600 may be overmolded onto the heating element 610. In other embodiments, the heating element 610 may not be embedded, but is at least in physical contact with the bottom side 605. This allows for more efficient heat transfer directly to the cooking surface 602 and/or food.

The cooking surface 602 may comprise a number of parallel ribs 603 that extend upwardly and are spaced apart by parallel valleys 604. Openings 606 in the valleys 604 may pass from the food contact surface to the bottom side 605.

A temperature probe 612 may have a plurality of individual sensors 614 spaced along the bottom side 605 of the cooking grate 600 and in contact therewith. Using a plurality of temperature sensors 614 across each cooking zone (or individual cooking grate 600) allows detection of the rise of the temperature during an initial heat-up and can be used to inform the user about the perfect time of placing the food on the designated cooking zone. As the cooking grate 600 may be made of materials with high heat conductivity, each temperature sensor can be used to estimate the rate of heat transfer at the given zone or specific location within a zone. In some embodiments, calculations can involve a power supply rate and the ambient temperature as well.

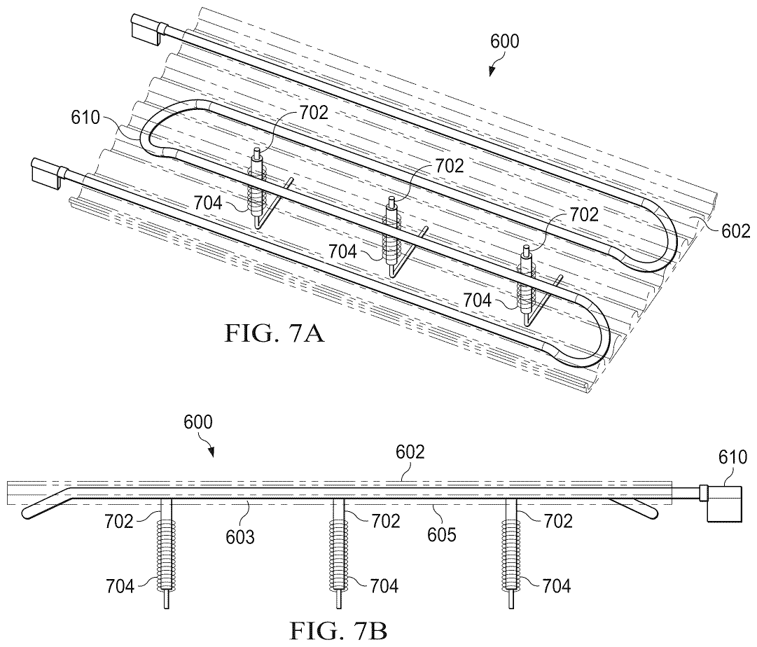

Referring now to FIG. 7A, a perspective view of another embodiment of a cooking grate according to aspects of the present disclosure is shown. FIG. 7B is an end view of the cooking grate of FIG. 7A. The grate 600 as shown in FIG. 7 provides a plurality of separate temperature probes 702 spaced apart in contact with the bottom side 605 of the grate 600. The probes 702 are maintained in contact with the bottom side 605 by springs 704.

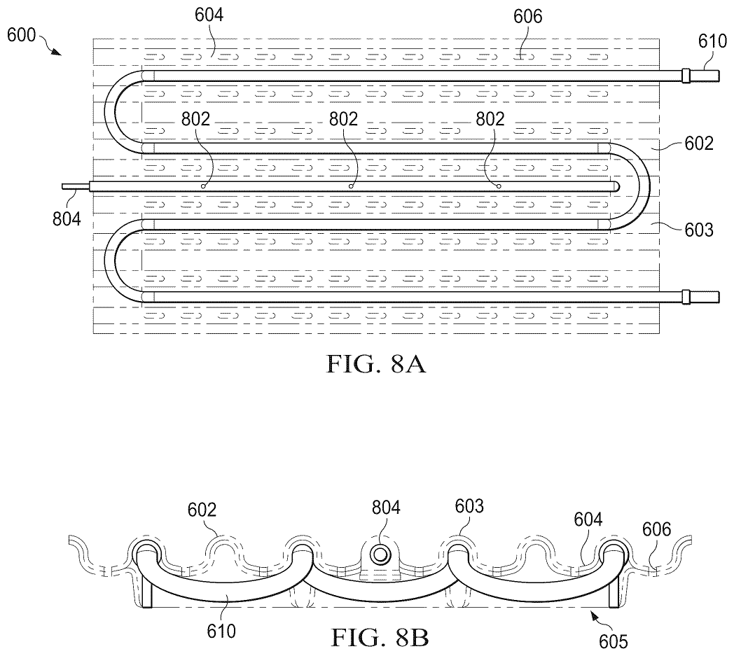

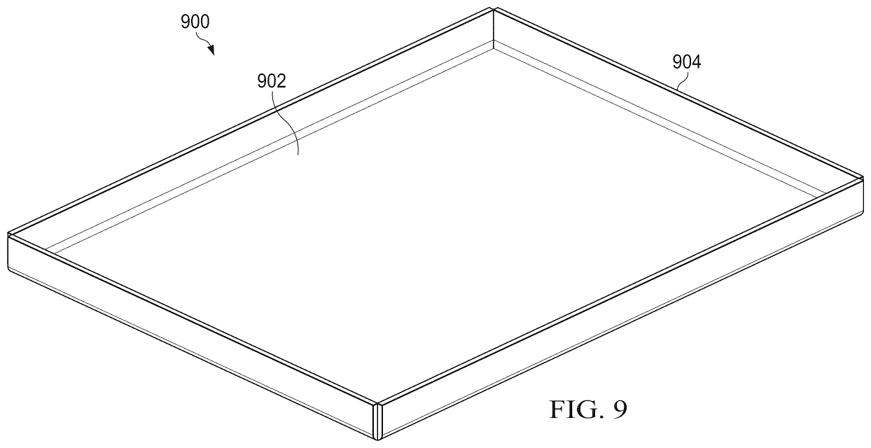

Referring now to FIG. 8A, a plan view of another embodiment of a cooking grate according to aspects of the present disclosure is shown. FIG. 8B is an end view of the cooking grate of FIG. 8A. The grate 600 as shown in FIG. 8 has a temperature probe 804 embedded into the cooking grate 600. The probe 804 is therefore situated between the food contact surface 602 and the bottom surface 605. The probe 804 may be located within one of the parallel ribs 603, and possibly a medially or centrally located rib. Separate temperature sensors 802 may be provided along a length of the probe 804 to allow temperature to be taken at multiple locations.

Referring now to FIG. 9, a perspective view of a griddle 900 according to aspects of the present disclosure is shown. The griddle 900 may used in place of all or a portion of the cooking grate 206. The griddle 900 may be constructed of stainless steel, cold rolled steel, hot rolled steel, cast iron, porcelain coated steel, multi-clad steel (such as stainless steel-aluminum-steel), aluminum, copper, and/or other materials. The griddle 900 may comprise a cooking surface 902, possibly surrounded by a boundary wall 904. The griddle 900 may be generally rectilinear or square in outline.

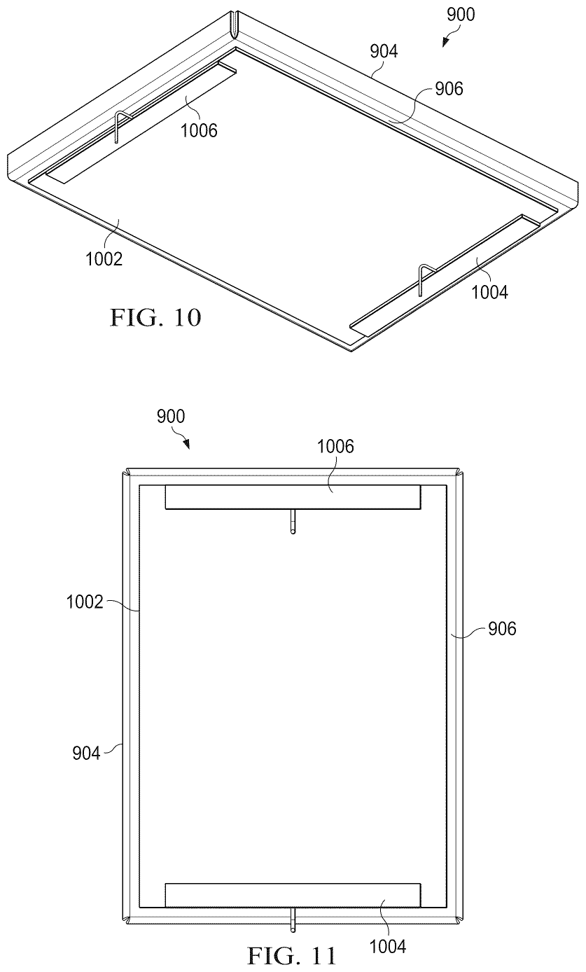

Referring now to FIG. 10 an inferior perspective view of the griddle 900 of FIG. 9 is shown. FIG. 11 provides a bottom view of the griddle 900. In some embodiments of the present disclosure, an electric grill provides enhanced cooking capability by utilizing a specific griddle heating element 1002 applied to the a bottom surface 906 of the griddle 900. The heating element 1002 comprises a graphene heating element which may include one or more layers of graphene or graphene or carbon film. Electrodes 1004, 1006 allow the graphene heating element 1002 to be energized. An insulating layer may interpose the graphene heating element 1002 and the bottom 906 of the griddle 900 to provide electrical isolation of the graphene heating element 1002 and prevent shorting.

The graphene heating element 1002 may comprise a plurality of layers of graphene, where each layer of graphene need not cover the entire surface, but each layer overlaps the other layers to provide sufficient electrical connection. When a voltage is applied across the electrodes 1004, 1006 the flow of electrons through the graphene encounters resistance resulting in an increased temperature in the graphene heating element 1002. With the graphene in thermal contact with the griddle surface (but electrically isolated from the griddle), the increased temperature of the graphene heating element 1002 produces a conductive thermal energy transfer to the griddle 900 to heat it. The direct conduction of thermal energy without any radiative step produces a more thermally efficient heating element.

In some embodiments, the graphene layer(s) of the graphene heating element 1002 may comprise graphene flakes. The bottom 906 of the griddle 900 may be coated with a thermally-conductive but electrically-isolating coating material over and/or under the graphene flakes. In various embodiments, the graphene comprises a thin film (possibly mono-atomically applied) or a thick film. In other embodiments, the graphene layer comprises carbon flakes, pieces, or layers that are not strictly defined as graphene.

In some embodiments, one or more graphene layers are sandwiched between the bottom 906 of the griddle a supporting layer. The supporting layer may comprise metal, glass, plastic, polymer, rubber or some other supportive material.

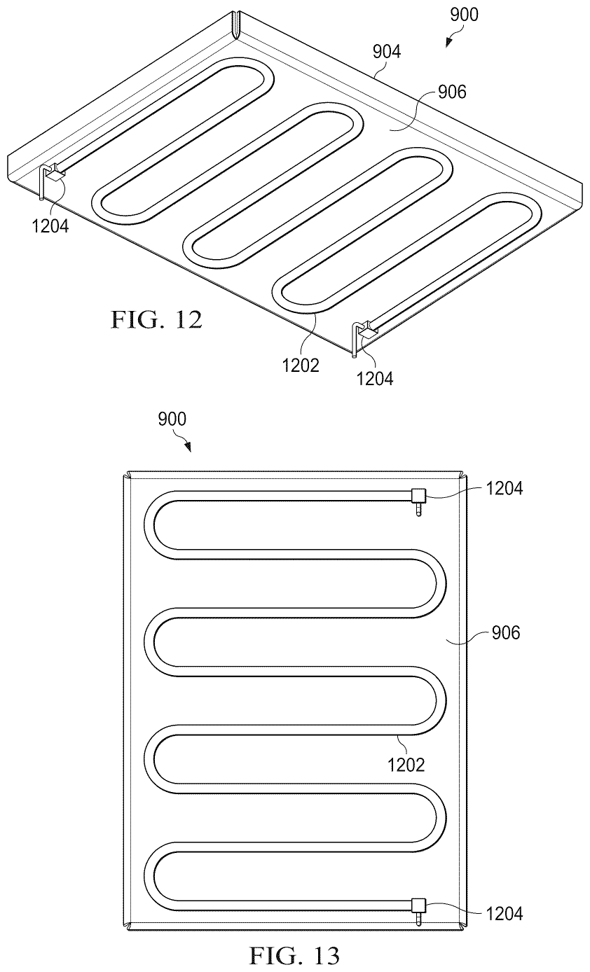

The pattern or general topology of the graphene heating element 1002 may take the form of a solid heating element covering the entire cooking area as in FIGS. 10-11. However, as shown in FIGS. 12-13, a graphene layer or heating element 1202 may have a shape according to a specified pattern meant to find the balance of material usage and evenness of the temperature distribution. Again, electrical isolation of the graphene heating element 1202 may be provided via coatings and the like. Electrodes 1204 allow for application of a voltage to the graphene heating element 1202.

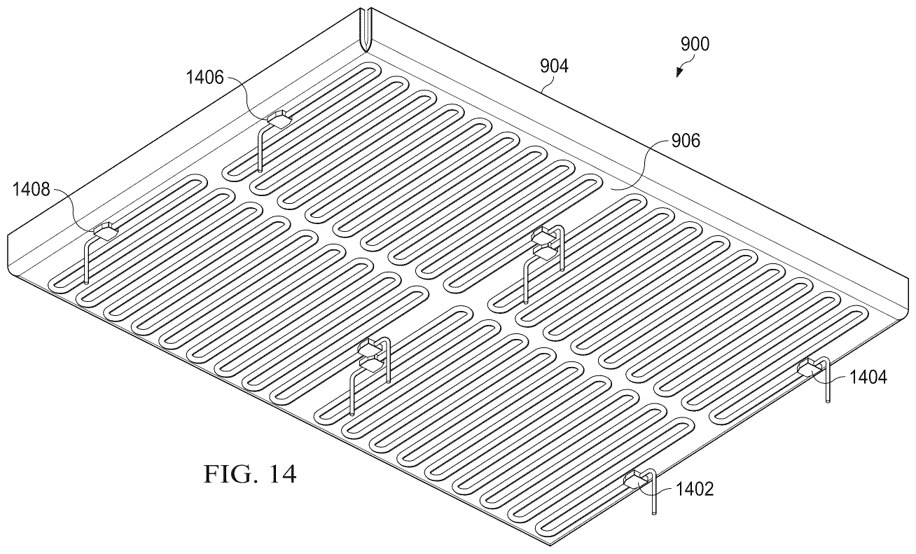

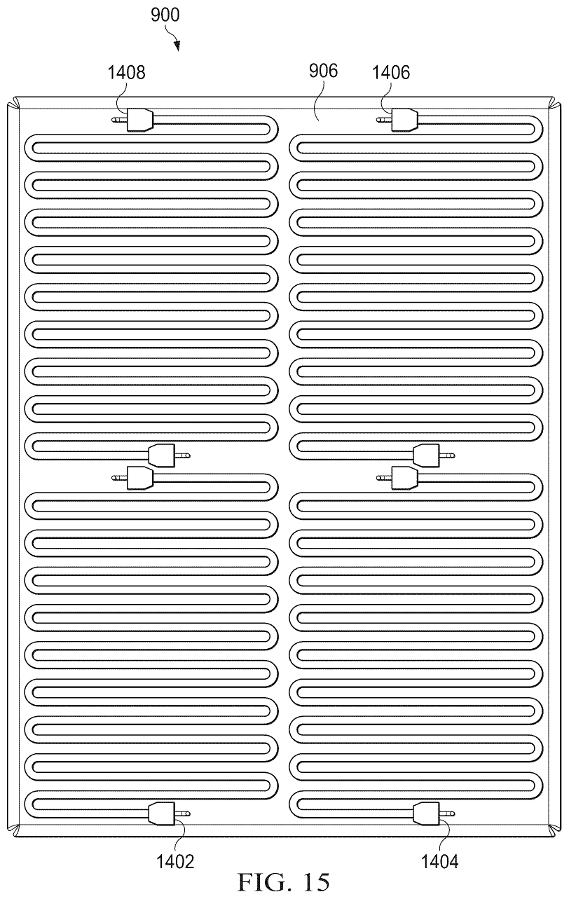

Referring now to FIG. 14, a bottom perspective view of another embodiment of a griddle according to aspects of the present disclosure. FIG. 15 is a bottom view of the griddle of FIG. 14. As shown, the griddle 900 may be split into a plurality of zones producing independent, zonal cooking functionality. Here, separate and electrically isolated (from one another and from the bottom surface 906) graphene heating elements 1402, 1404, 1406, 1408 are provided. More or fewer graphene heating elements may be utilized with different embodiments.

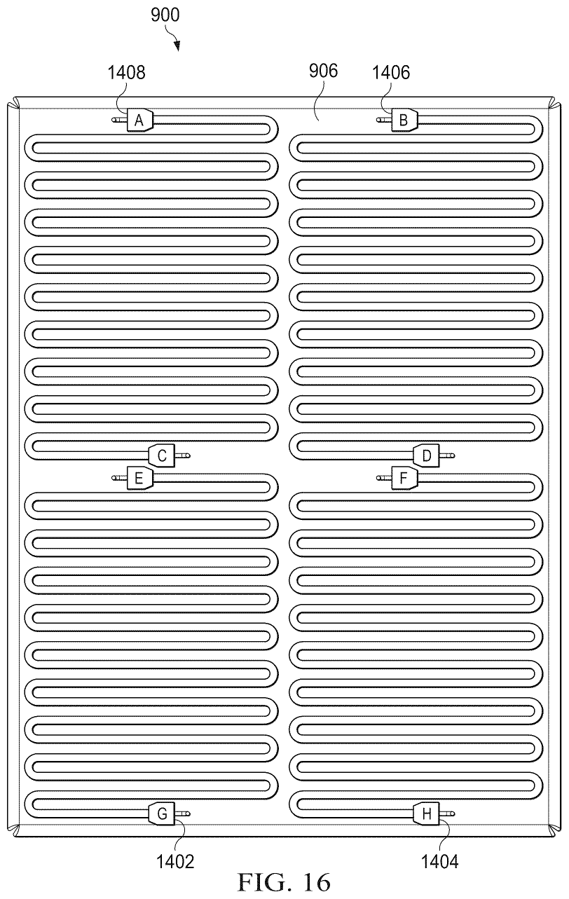

As shown in FIG. 16, when a plurality of graphene heating elements is utilized to create a plurality of cooking zones, the corresponding electrodes may be connected in such a way to limit the needed number of electrical switches to control the electrical power going to each zone. For example, in FIG. 16, electrodes C and D may be connected electrically to electrodes E and F respectively, producing two cooking zones instead of four. In other embodiments the plurality of graphene heating elements (e.g., 1402, 1404, 1406, 1408) may be connected in a grid like structure, which in conjunction with an appropriate number of electrical switches, may allow the specific zone(s) to be powered while the other remains off.

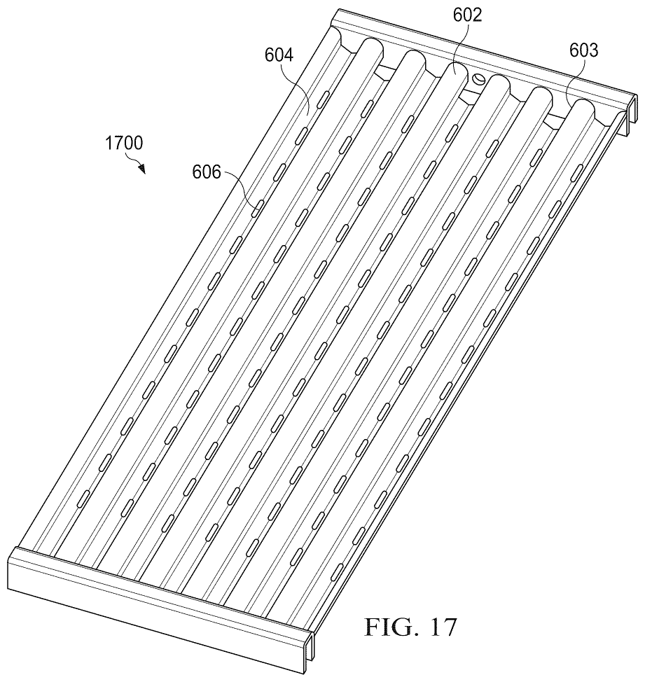

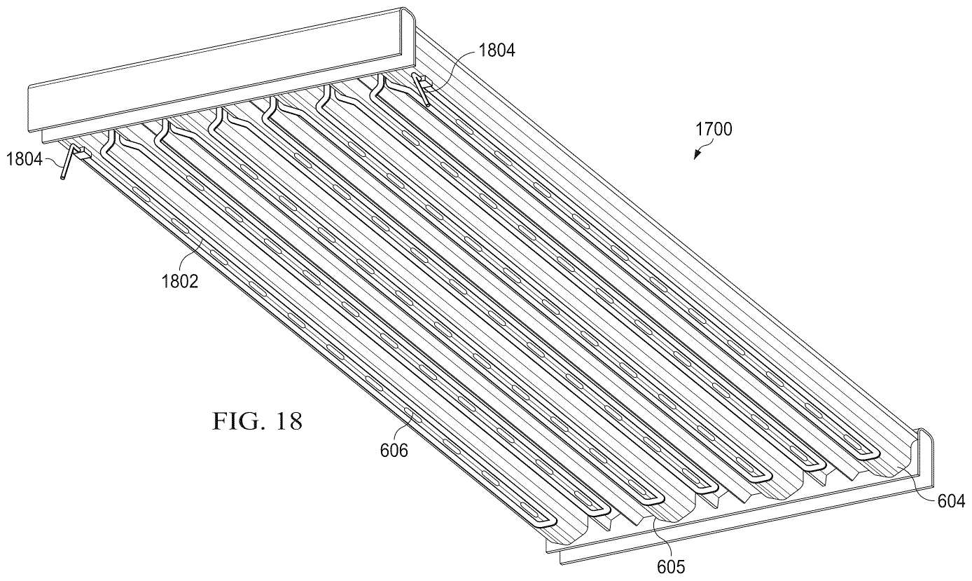

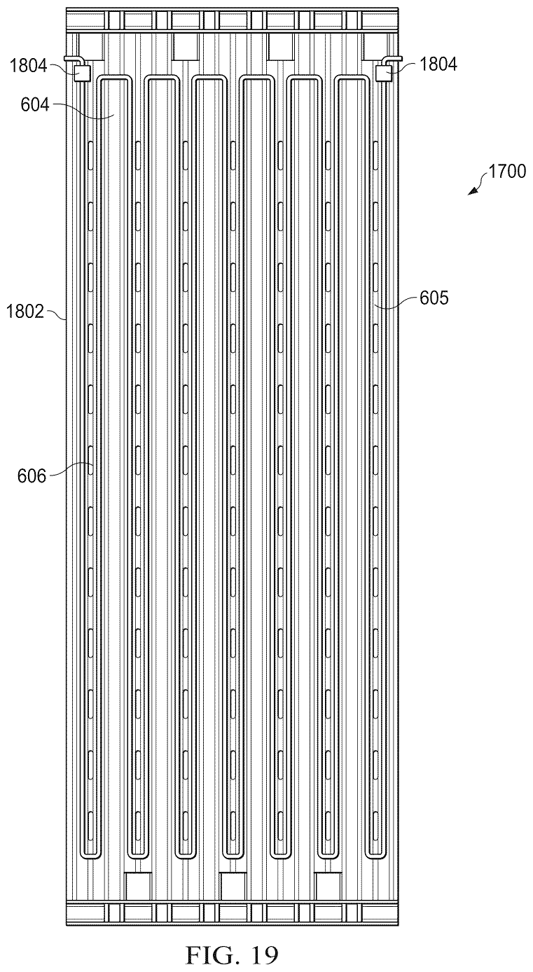

Referring now to FIG. 17, a perspective view of one embodiment of a cooking grate 1700 according to aspects of the present disclosure is shown. FIG. 18 is a bottom perspective view of the cooking grate 1700. FIG. 19 is a bottom view of the cooking grate 1700. The cooking grate 1700 may represent all or a portion of cooking grate 206. The cooking grate 1700 may be considered an infrared grill grate. A cooking surface 603 provides a plurality of spaced apart parallel ribs 603. Valleys 604 may separate adjacent ribs 603. The valleys 604 may define slits or openings 606 for drainage of grease and other cooking fluids.

A graphene heating element 1802 may be applied to a bottom 605 of the grill grate 1700. The heating element 1802 may comprise a single layer or multiple layers of graphene in thermal connection but electrical isolation from the bottom 605 of the grate 1700. The graphene heating element 1802 is shown winding back and forth adjacent rows of openings 606 in the grate 1700. Electrodes 1804 are provided for application of power or voltage to the graphene heating element. Other sizes, shapes, and/or topologies of the graphene heating element 1802 are possible as well. A thin or thick film comprising graphene or carbon flakes can be pasted or applied as the graphene heating element 1802 to the bottom side 605 of the grill grate 600. In some embodiments, a graphene layer or heating element 1802 may be embedded into the grate 600 (e.g., similar to FIGS. 6A-8B).

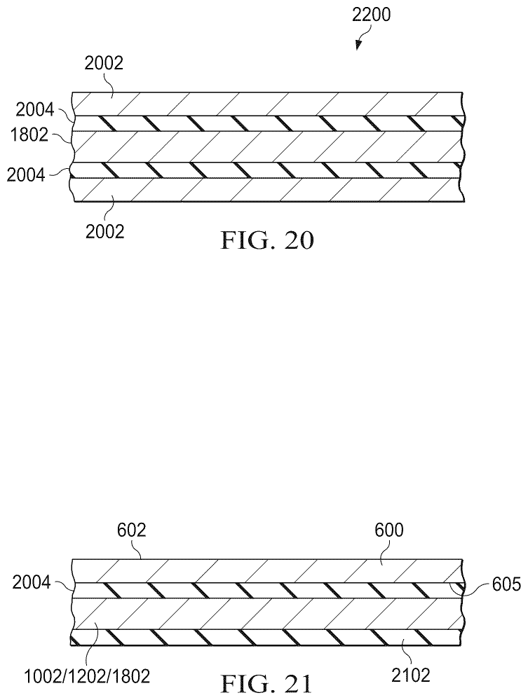

Referring now to FIG. 20, a side cutaway view of a portion of a graphene heating element 1802 formed into an emitter plate 2000 is shown. A graphene layer or heating element may be sandwiched between two infrared emitter surfaces 2002 that either form the grill grate (e.g., 600), partially forms the grill grate, or is placed just underneath the grill grate. For improved browning of the food during the cooking process for both grills and griddles, the graphene layer 1802, when sandwiched between two infrared emitter surfaces 2002, may be placed in the lid 208 of the grill 200. Thermally conductive but electrically isolating layers 2004 may interpose the emitter surfaces 2002 and the graphene layer. Electrodes may be routed in to the graphene heating element or layer 1802.

Referring now to FIG. 21, a side cutaway view of the application of graphene layer (e.g., 1002, 1202, 1802) to a bottom surface 605 of a grate 600 is shown. A thermally conductive but electrically isolating layer 2004 may interpose the graphene heating element 1002/1202/1802 and the bottom surface 605. An outer insulative or support layer 2102 may cover the graphene heating element 1002/1202/1802.

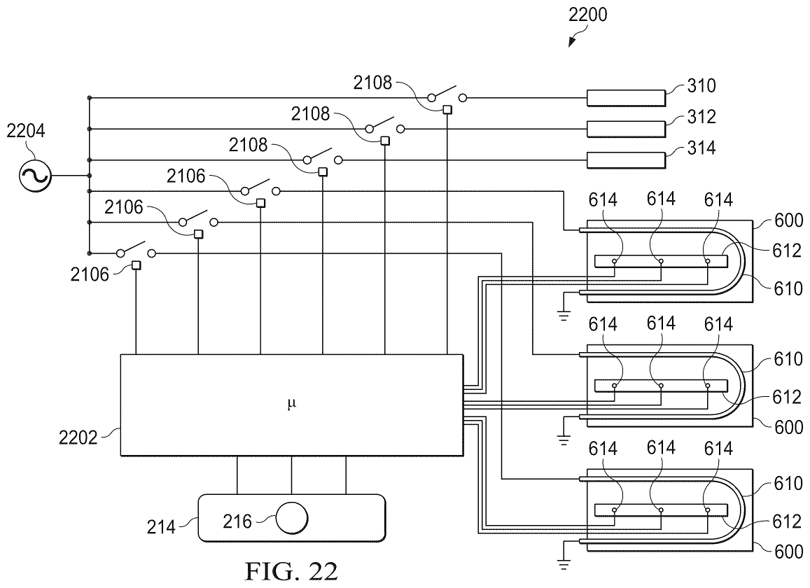

Referring now to FIG. 22, a simplified schematic diagram of the grill 200 with control system is shown. A control system of the grill 200 may be based upon a microcontroller 2202 or other programmable device. The microcontroller 2202 may utilize the described controls and inputs to accomplish various operations with the grill 200 and the variations described herein. The microcontroller may direct power from a power supply 1802 to the various heating elements 610 of cooking grate 600 via series of relays 2106. Relays 2106 may allow for operation of searing tubes 310, 312, 314 via the power supply 1802 as well. In some embodiments, each separate cooking grate 600 may be considered a separate cooking zone.

The power supply 1802 may be AC mains power. In other embodiments, it may comprise a DC source such a high capacity battery. AC/DC conversion hardware as known to the art is not shown. Similarly, not every individual lead or connection as would be known to one of skill in the art is shown in the simplified schematic.

User control over the grill 200, and the microcontroller 2202 specifically, may be accomplished via control panel 214 and control knob 216. Additional controls known to the art may be utilized. A touch screen may be provided. In some embodiments, a user may interact with the microcontroller 2202 using a mobile device app and Wi-Fi, Bluetooth®, a cloud service or another protocol.

The microcontroller 2202 may be operative to detect where heat should be directed (via the temperature probes 612 or individual sensors 614) and at what intensity, as well as how it should transit or be applied through cooking time.

According to embodiments of the present disclosure, the system 2200 system has an enhanced cooking capability to fully deploy available electrical power more efficiently, whether in alternating current (AC) or direct current (DC) or AC+DC form (e.g., power supply 1802). Warmup and recovery times are thereby reduced.

A set of temperature sensors dedicated to monitor individual cooking zones (e.g., temperature probes 612 or individual sensors 614) can provide data to the microcontroller 2202 as the cooking grate 600 is heating up to the specific temperature target for that zone. For example, if one zone is considered for grilling thick steaks and another zone is considered for cooking vegetables, the microcontroller 2202 using the inputs from the temperature probes 612 or sensors 614 can provide appropriate levels of powers to each zone. Depending on the desired cooking sequences, the microcontroller 2202 can manage to reach the specific cooking temperature for all zones at once or at different times based on the needed cooking time for each specific item. As each individual zone reaches the customized targeted temperature, the system microcontroller 2202 communicates with the user to place the food items on their designated zone(s).

Presence of cold food items may be recognized by the microcontroller 2202 via temperature sensors 214 or probes 212. Various embodiments of the present disclosure may be provided with small weight sensors or optical sensors to detect food. Data may be provided by temperature sensors monitoring different segments of each cooking grate, and temperature sensor(s) monitoring the air temperature in the cooking chamber (e.g., under the lid 208). The microcontroller 2202 ensures a suitable rate (level) of heat to each segment of the cooking surface. Depending on the food type, food temperature, and the elapsed cooking time, the microcontroller 2202 may energize searing tubes 310, 312, 314 for a desired level of top browning.

For thin or flat foods that need rotating or flipping (such as steaks and burger patties), the microcontroller 2202 may calculate the time left prior to the flip time and communicates such data or information to the user. Calculations may be based on the type of the food (thermal properties of the food), the supplied rate of heat transfer, the measured temperatures of the cooking grate and the cooking chamber air surrounding the food, as well as the desired level of doneness selected by the user. The microcontroller 2202 can similarly calculate the time to the end of cooking, and provide the consumer with a count-down clock or other related information.

In some embodiments, over the time the microcontroller 2202 uses each individual user's feedback to better adjust the cooking characteristics of the grill/griddle to each consumer. As an example, while one user might consider a given level of doneness for steaks perfect, another user may prefer it more (or less) cooked. As the individual provides his/her preferences, the system becomes more trained to the specific tastes of the individual.

In some embodiments, the power rate (level) and timing (on/off) supplied to the main cooking surface elements and surrounding graphite tubes can follow fixed values optimized for thermal inertia of cooking surface. This can be beneficial, for example, for applications with low heat and long cooking time, such as rotisseries.

It should be understood that the system as shown in FIG. 22 allows the substitution of graphene heating elements as described herein (e.g., 1002, 1202, 1208) for the resistive heating elements 610. Appropriate circuitry may be employed to measure the change in the thermal resistance of the graphene heating elements as it heats up. By tracking the changes in the resistance through time and assuming the graphene heating element is in thermal equilibrium with the griddle cooking zone, the change in temperature of the cooking zone is measured and tracked. The tracking/measuring of the temperature of the cooking zone allows the sensing of when food is placed on the cooking zone. In some cases, instead of thermal equilibrium, the graphene layer temperature may be correlated to that of the cooking zone.

This food sensing capability may be used in conjunction with the control system 2200 to direct the available power into a cooking zone(s) where food is present. In complex scenarios, with more food items placed on more than one cooking zone, the microcontroller 2202 may direct the power in such a way to provide the electrical energy where it is needed most to provide a uniform cooking experience.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. An electric cooking device comprising:
an electrically powered heat source that provides thermal energy to a cooking surface; and
a lid that closes to cover the cooking surface, the lid having a searing tube that provides radiative heat toward the cooking surface.

2. The electric cooking device of claim 1, wherein the lid has at least one other searing tube that provides radiative heat toward the cooking surface.

3. The electric cooking device of claim 2, wherein the searing tube and the at least one other searing tube are separately activated by a controller.

4. The electric cooking device of claim 1, wherein the electrically powered heat source comprises a resistive heating element.

5. The electric cooking device of claim 4, wherein the cooking surface is provided by a cooking grate in contact with the resistive heating element.

6. The electric cooking device of claim 5, wherein the resistive heating element is at least partially embedded into the cooking grate.

7. The electric cooking device of claim 6, further comprising a temperature probe in contact with a bottom side of the cooking grate on an opposite side from the cooking surface.

8. The electric cooking device of claim 6, further comprising a plurality of temperature sensors in contact with a bottom side of the cooking grate on an opposite side from the cooking surface.

9. The electric cooking device of claim 6, further comprising a temperature probe embedded in the cooking grate.

10. The electric cooking device of claim 6, further comprising a plurality of temperature sensor embedded in the cooking grate.

11. The electric cooking device of claim 1, wherein the cooking surface comprises a griddle and the electrically powered heat source comprises a graphene heating element applied to the griddle on a back side opposite from the cooking surface.

12. The electric cooking device of claim 1, wherein the cooking surface comprises a cooking grate and the electrically powered heat source comprises a graphene heating element applied to the cooking grate on a back side opposite from the cooking surface.

13. The electric cooking device of claim 12, wherein the cooking grate comprises an infrared cooking grate with a plurality of spaced apart ribs on the cooking surface and a plurality of valleys between adjacent ones of the ribs, the plurality of valleys each defining a plurality of openings from the cooking surface through the cooking grate.

14. An electric cooking device comprising:
a plurality of cooking grates forming a cooking surface, each of the plurality of cooking grates having a separate electrically powered heat source; and
a lid that closes to cover the cooking surface, the lid having a plurality of separately activated searing tube that provide radiative heat toward the cooking surface.

15. The electric cooking device of claim 14, wherein the separate electrically powered heat source of each of the plurality of cooking grates heats the respective cooking grate through contact with the respective cooking grate.

16. The electric cooking device of claim 15, wherein the separate electrically powered heat source of each of the plurality of cooking grates comprises a resistive heating element.

17. The electric cooking device of claim 16, the separate electrically powered heat source of each of the plurality of cooking grates is at least partially embedded into the respective cooking grate.

18. The electric cooking device of claim 17, wherein each of the plurality of cooking grates is in contacted by a temperature probe.

19. The electric cooking device of claim 14, wherein each of the plurality of cooking grates is heated by a graphite heating element applied to the cooking grate on an opposite side from the cooking surface.

20. An electric cooking device comprising:
a griddle forming at least part of a cooking surface, the griddle being heated by a graphene heating element applied to a side of the griddle opposite the cooking surface; and
a lid that closes to cover the cooking surface, the lid having a plurality of separately activated searing tube that provide radiative heat toward the cooking surface.
